(19) United States
(12) Patent Application Publication
(10) Pub. No.: US 2019/0148714 A1
(43) Pub. Date: May 16, 2019

(54) IMPROVED POLYMER LAYER MORPHOLOGY FOR INCREASED ENERGY AND CURRENT DELIVERY FROM A BATTERY-SUPERCAPACITOR HYBRID

(71) Applicants: Cambridge Display Technology Limited, Godmanchester (GB); Sumitomo Chemical Company Limited, Tokyo (JP)

(72) Inventors: Samuel Richardson, Godmanchester (GB); Jonathan Pillow, Godmanchester (GB)

(73) Assignees: Cambridge Display Technology Limited, Godmanchester (GB); Sumitomo Chemical Company Limited, Tokyo (JP)

(21) Appl. No.: 16/314,653

(22) PCT Filed: Jun. 8, 2017
(86) PCT No.: PCT/GB2017/051661

§ 371 Date: Dec. 31, 2018

(30) Foreign Application Priority Data
Jun. 24, 2016 (GB) 1611025.6

(51) Int. Cl. H01M 4/137; H01M 4/1399; H01M 4/60; H01M 4/04; H01G 11/24; H01G 11/48

(52) U.S. Cl. CPC H01M 4/137; H01M 4/1399; H01M 4/604; H01M 2004/021; H01M 4/0483; H01G 11/24; H01G 11/48; H01M 4/608

(57) ABSTRACT

This invention relates to polymer-based electrodes comprising at least one layer containing: a continuous, solid and porous electroactive polymer material, and liquid electrolyte present in the pores of the electroactive polymer material. As a result of the modified morphology of the polymer layer thin-film charge-storage devices using these polymer-based electrodes exhibit improved charge-storage and current output and enable manufacturing of a gradual continuum between batteries and supercapacitors. In addition, the invention relates to methods of producing the above polymer-based electrodes and thin-film charge-storage devices.

### FIELD OF INVENTION

This invention relates to polymer-based electrodes and thin-film charge-storage devices comprising the same, which exhibit improved charge-storage and current output as a result of morphology modifications of the polymer layer. In addition, the invention relates to methods of producing the above polymer-based electrodes and thin-film charge-storage devices.

### BACKGROUND OF THE INVENTION

In the recent years, there has been a high interest in the development of thin film charge-storage devices which exhibit both excellent energy and power density.

Thin film batteries generally achieve high energy densities but typically provide low power due reversible coulombic reactions occurring at the electrodes, involving charge transfer and ion diffusion in electrode materials, thereby kinetically limiting the power delivery as well as the recharging time.

On the other hand, supercapacitors store energy through accumulation of ions on the electrode surface, i.e. through a coloumbic charge storage process. Accordingly, no redox reactions are required and the response to changes in the potential is not diffusion-controlled, so that supercapacitors may provide more power per unit mass than batteries and enable burst power supply for electric vehicles, for example. However, supercapacitors tend to have a relatively low energy storage.

Different commercial applications require different balances of characteristics between the two extremes of batteries and supercapacitors, but it is particularly desirable in certain circumstances for the charge-storage device to behave more like a supercapacitor. These characteristics particularly include the rapid acceptance or delivery of charge (providing a high current) as this is a feature that is not normally achievable with standard battery technology such as Li-Ion or Zn—MnO₂.

Thin film charge-storage devices based on electrodes comprising conjugated polymers have previously been demonstrated to offer good conductivity of both ions and charges that allow them to act as redox-active materials in charge-storage devices (see e.g. U.S. Pat. No. 4,442,187 A). In these, they show properties of both batteries and supercapacitors, depending on a number of factors including the degree of shielding of each charge from the next one along the polymer chain, and the relative mobility of charges and ions within the polymer layer. However, the predominant charge-storage mechanism is that of a battery, with a clearly defined redox potential (or range) below which the voltage output from the battery drops rapidly to zero. Also, pseudocapacitors have been described using conjugated polymers (e.g. PEDOT:PSS) to add a faradaic component to increase the capacity of an otherwise coloumbic charge storage system.

In order for a battery-type material to release charge it is necessary for both charges and ions to move through the layer—the charges towards or from the current collector and the ions from or towards (depending on the polarity and the overall ionic make-up of the system) the separator and the opposite electrode. Depending on the system, either the charge transport or the ion transport will be rate-limiting. However, in a typical system with a solid polymer layer and reasonable charge mobilities (around 10⁻³ cm²/Vs) it can be expected that the slowest mobility will be that of the ions, which tend to have mobilities in the range of 10⁻⁷ cm²/Vs. As these lag behind the movement of the charges they create an internal electric field that impedes the progress of the charges. Thus the mobility of the faster charges is reduced to that of the slower ions. To enable faster transfer of charges into or out of the polymer layer it is therefore necessary for the ion mobility to be increased.

Moreover, the thickness of polymer through which the ions must penetrate is likely to play a substantial role in determining how quickly the ions can move through, and results have shown that a thick film is likely to be harder to completely charge, and may not be straightforward to achieve the full theoretical charge capacity, as there may be regions of the film that ions cannot penetrate so easily. Other methods to enable ions to penetrate all of the polymer material as efficiently as possible must therefore be identified.

Methods have been described previously for increasing the mobility of ions in a polymer film by changing the composition of the conjugated polymer, by blending in or functionalising the conjugated polymer with moieties with ion miscible and/or transporting groups that typically have a higher polarity and have some ion-solvation properties (see e.g. WO 1999/066572 A1 or U.S. Pat. No. 6,096,453 A).

However, previous thin-film polymer charge-storage systems use neat-films of polymers, which tend to result in poor ion mobility, or used electropolymerised polymer over which there is little control possible over the morphology and hence the performance of the polymer.

Therefore, it remains desirable to provide polymer-based electrodes with further improved ion mobilities in order to enable manufacturing of a gradual continuum between batteries and supercapacitors, i.e. charge-storage devices which exhibit the advantages of both a high charge-storage and high current.

Furthermore, it would be desirable to provide simple and upscalable methods for optimising the morphology of a pre-formed electroactive polymer so that both the structure and stability of the polymer, the morphology of the polymer layer and the performance of the device can be optimised at the same time.

### SUMMARY OF THE INVENTION

The present invention solves these objects with the subject matter of the claims as defined herein. The advantages of the present invention will be further explained in detail in the section below and further advantages will become apparent to the skilled artisan upon consideration of the invention disclosure.

This invention describes methods to substantially improve the charge-storage and current output of a polymer thin-film charge-storage device by modifying the morphology of the polymer film to substantially enhance the movement of ions. In particular, the ability to take advantage of the plastic and other processing properties of the polymers, enables them to be moulded in a number of different ways, and using a variety of methods. New structures that can be formed include, but are not limited, to nano/microparticles, nano/microfibers, foams and gels, all of which have different relative advantages. Furthermore, the use of these new morphologies enables the preparation of a gradual continuum between battery (higher charge-storage, lower current) and supercapacitor (lower charge-storage, higher current) performance that can therefore allow a device to be prepared according to the needs of a specific application.

Generally speaking, the present invention relates to a polymer-based electrode comprising at least one layer containing: a continuous, solid and porous electroactive polymer material, and liquid electrolyte present in the pores of the electroactive polymer material.

In a further aspect, the present invention relates to a thin film charge-storage device comprising two electrodes between a separator, wherein at least one of the electrodes is the aforementioned polymer-based electrode.

Another aspect of the present invention is a method of forming a polymer-based electrode for a thin film charge-storage device, the method comprising: a step of processing a pre-formed electroactive polymer so as to provide a continuous and solid electroactive polymer material having a porous structure.

Preferred embodiments of the polymer-based electrode according to the present invention and other aspects of the present invention are described in the following description and the claims.

### BRIEF DESCRIPTION OF THE DRAWINGS

FIG. 1a schematically illustrates the general architecture of an electroactive polymer-based electrochemical capacitor and the electron flow and ion movement during charge.

FIG. 1b schematically illustrates the electron flow and ion movement during discharge.

FIG. 2 is a graph showing the charge-voltage output from half-cell devices, wherein the electroactive polymer layer is either a thin solid film or a porous layer as employed in the present invention.

FIG. 3 is a graph showing the charge-voltage output from full-cell devices with either thin solid films or porous layers or electroactive polymer as employed in the present invention.

FIG. 4 is a graph showing the capacitance for devices with anodes featuring polymer films with and without incorporation of liquid solvent during fabrication.

### DETAILED DESCRIPTION OF THE INVENTION

For a more complete understanding of the present invention, reference is now made to the following description of the illustrative embodiments thereof:

### Polymer-Based Electrodes

In a first embodiment, the present invention relates to a polymer-based electrode comprising at least one layer containing: a continuous, solid and porous electroactive polymer material, and liquid electrolyte present in the pores of the electroactive polymer material.

The term “liquid electrolyte”, as used herein, denotes electrolytes that are liquid at room temperature (25° C.). As examples thereof, electrolyte salts dissolved in appropriate solvents as commonly used in the art or ionic liquids that are typically liquid below 100° C. may be mentioned, the latter including, but not being limited to ammonium-, imidazolium-, phosphonium-, pyridinium-, pyrrolidinium-, and sulfonium-based ionic liquids. As the use of ionic liquids allows volatile and hazardous conventional solvents to be eliminated and improves the operational stability of these devices, ionic liquids are preferable as liquid electrolytes. In comparison to solid electrolytes, such as e.g. polymer electrolytes, liquid electrolytes generally achieve substantially higher ion mobilities. This liquid electrolyte phase needs to be mixed as effectively as possible with the polymer so that the longest distance from the liquid phase to any part of the polymer is minimized, while at the same time ensuring that the overall proportion of the liquid phase is as low as possible (to enable higher energy content). Preferably, the liquid phase is distributed continuously throughout the entire thickness of the electroactive polymer.

It is essential that the electroactive polymer material is continuous to enable free movement of charges throughout the whole of the polymer layer.

The thickness of the layer containing the continuous, solid and porous electroactive polymer material may be chosen appropriately depending on the required purpose and is typically in a range of between 0.1 μm to 80 μm. Advantageously, when compared to polymer-based electrodes made of non-porous polymer films, higher thicknesses may be employed without negatively affecting the charge capacity.

The porous structure of electroactive polymer material may take a large variety of different forms depending on the desired applications and the available manufacturing conditions and resources, a few of which will be explained hereinbelow.

In a preferred embodiment, the electroactive polymer material is present in the form of an aggregate of electroactive polymer particles having an average particle diameter of between 1 nm and 10 μm, further preferably between 30 nm and 1 μm.

In an alternatively preferred embodiment, the electroactive polymer material is present in the form of an aggregate of electroactive polymer fibers, i.e. nano and/or microfibers having an average diameter of between 1 nm and 10 μm, preferably between 10 nm and 5 μm. In a further preferred embodiment, the electroactive polymer fibers are split microfibers, which will be explained in further detail below in conjunction with the second embodiment. Nanofibers with diameters down to 1 nm to 1 μm may be prepared by using techniques such as electrospinning. Providing the porous electroactive polymer in the form of an aggregate of electroactive polymer fiber has the advantage that excellent charge mobility is attained along the fiber axis, while the ions can move through the pores between the fibers, thereby giving high mobility to both species and a correspondingly high output current.

The average particle diameter may be determined by common techniques, such as by a laser distribution analyzer or by analysis of scanning electron micrographs. The average diameter of fibers may likewise be determined by known techniques, e.g. by image analysis tools coupled with electron microscopy.

In an alternatively preferred embodiment, the electroactive polymer material is present in the form of an open-cell foam, preferably a nano-, ultramicrocellular- or microcellular open-cell foam having a foam cell size between 0.1 nm and 10 μm, which may be manufactured by foaming techniques known in the art (e.g. by use of chemical blowing agents, physical blowing agents.

In another preferred embodiment, the at least one layer is present in the form of a gel; wherein the gel comprises the cross-linked electroactive polymer material as a solid polymer network into which a liquid phase comprising the liquid electrolyte is dispersed. The gel is generally characterized in that it comprises a solid polymer network, into which the liquid phase comprising the electrolyte may be dispersed. The solid polymer network is typically a covalent polymer network formed by cross-linking polymer chains or by non-linear polymerization, a polymer network formed through aggregation of polymer chains (e.g. by hydrogen bonding or crystallization) and/or a polymer network formed through glassy junction points. While it is preferable from the standpoint of electrical conductivity that the polymer network of the gel is formed by the electroactive polymer itself, the electroactive polymer may alternatively also be dispersed along with the electrolyte into a network formed by a different polymer provided that the electroactive polymer forms a continuous pathway throughout the entire thickness of the electroactive polymer, that effective mixing of the electroactive polymer and the liquid electrolyte is ensured and that the polymer is not fully dissolved in the electrolyte so that it cannot leave the layer. Using polymer gels advantageously allows to gradually adjust the battery/supercapacitor characteristics depending on the particular application in a simple manner by setting the molar ratio of electroactive polymer to electrolyte. For example, the molar ratio of electroactive polymer to electrolyte may be adjusted to be approximately equal (e.g. 45:55 to 55:45) to provide for a relatively high charge-storage content, while gels with excess proportions of electrolyte ions (e.g. a molar ratio of 10:90 to 45:55) to will be able to release charge more quickly and thus lead to charge storage device attributes closer to a supercapacitor.

In another preferred embodiment, the at least one layer exhibits a non-planar surface. Such a patterned structure may be achieved by appropriate techniques known in the art, e.g. by using patterned molding templates or by physically embossing the layer, which allows forming physical pathways into the polymer layer so that the electrolyte ions can penetrate it more easily. Depending on whether the pathways are continuous throughout the thickness of the polymer layer, this embodiment may be used as an alternative or in combination with the above-described porous structures.

The term “electroactive polymer”, as used herein, denotes a polymer which exhibits variable physical and/or chemical properties resulting from an electrochemical reaction within the polymer upon application of an external electrical potential, and must be thus distinguished from electrochemically inert or insulating materials, such as porous separator layer supports.

In a preferred embodiment of the polymer-based electrode according to the present invention, the polymer constituting the electroactive polymer material is a conjugated organic polymer, more preferably an n-type or a p-type conjugated organic polymer. In this connection, it is to be noted that the expression “n-type or p-type conjugated organic polymer” denotes conjugated organic polymers that are n-type cation-doped in the charged state or p-type anion-doped in the charged state, respectively.

The p-type conjugated organic polymer is not particularly limited and may be appropriately selected from standard electron donating conjugated organic polymers which are readily oxidized in relation to a high workfunction electrode so as to form stable oxidation products. Suitable compounds will be known to the person skilled in the art and are described in the literature. In a preferred embodiment, the p-type conjugated organic polymer is a co-polymer including alternating, random or block copolymers. As exemplary p-type conjugated organic polymers, polymers selected from conjugated hydrocarbon or heterocyclic polymers may be mentioned. As examples, in-chain conjugated (co-)polymers comprising as monomer units one or more selected from the group consisting of acene, aniline, azulene, benzofuran, fluorene, furan, indenofluorene, indole, phenylene, pyrazoline, pyrene, pyridazine, pyridine, diarylalkylamine, triarylamine, phenylene vinylene, thiophene, 3-substituted thiophene, 3,4-bisubstituted thiophene, selenophene, 3-substituted selenophene, 3,4-bisubstituted selenophene, bisthiophene, terthiophene, bisselenophene, terselenophene, thieno[2,3-b]thiophene, thieno[3,2-b]thiophene, benzothiophene, benzo[1,2-b:4,5-b′]dithiophene, isothianaphthene, monosubstituted pyrrole, 3,4-bisubstituted pyrrole, 1,3,4-oxadiazoles, isothianaphthene, and derivatives thereof may be mentioned. Preferred examples of p-type organic semiconductors are in-chain conjugated (co-)polymers of monomers selected from at least one, more preferably at least two of the group of fluorenyl derivatives, phenylene derivatives, aniline derivatives, dialkylarylamines, diarylalkylamines, diarylamines, triarylamines and heteroaromatic hydrocarbons (including thiophene derivatives, dithienes, and benzothiophene derivatives). It is understood that the p-type conjugated organic polymers may also consist of a mixture of a plurality of the above-mentioned polymers.

The n-type polymers are also not particularly limited and may be suitably selected from electron accepting materials which are readily reduced in relation to a low workf unction electrode so as to form stable reduction products. Suitable n-type polymers will be known to the skilled artisan and may consist of a mixture of a plurality of electron accepting materials. Preferred examples of n-type organic semiconductors are in-chain conjugated (co-)polymers of monomers selected from the group of fluorenyl derivatives, heteroaromatic hydrocarbons (such as e.g. benzothiadiazole, thiophene, dithiene, benzothiophene, azafluorene, quinoxaline, triazine and their derivatives (e.g. 1,3,5-triazine derivatives), conjugated aromatic hydrocarbons (e.g. arenes, acenes), and carbonyl-based monomers (such as fluorenone derivatives).

It is to be understood that electroactive polymer as used in the present invention may generally comprise cross-linking units, i.e. functional groups which enable to bond the polymer chains, which may be appropriately chosen by the skilled artisan.

In addition, the electroactive polymer layer may comprise further additives, such as e.g. plasicizers, surfactants, cross-linking agents or low-molecular weight compounds.

While the polymer-based electrode according to the present invention may consist of the layer containing a continuous, solid and porous electroactive polymer material and liquid electrolyte present in the pores of the electroactive polymer material, it may comprise further layers that are conventionally used in the preparation of electrodes for thin film devices. For example, the layer comprising the porous electroactive polymer may be combined with one or more layers that may be polymeric or non-polymeric (e.g. a current collector layer) and/or comprise material embedded into the respective polymer films (e.g. a conductive material for electrode connection etc.). Suitable materials for current collector layers include material that is selected from the group consisting of porous graphite, porous, highly doped inorganic semiconductor, highly doped conjugated polymer, carbon nanotubes or carbon particles dispersed in a non-conjugated polymer matrix, aluminum, silver, platinum, gold, palladium, tungsten, indium, zinc, copper, nickel, iron, lead, lead oxide, tin oxide, indium tin oxide, graphite, doped silicon, doped germanium, doped gallium arsenide, doped polyaniline, doped polypyrrole, doped polythiophene, and their derivatives. If the electroactive polymer layer itself serves as the current collector, conductive particles (such as carbon nanotubes or carbon particles, for example) may be dispersed in the polymer layer at a concentration higher than a percolation threshold concentration. In addition to the above, a substrate layer may be provided adjacent to the electroactive polymer layer, e.g. as a mechanical support.

### Thin Film Charge Storage Devices

A second embodiment of the present invention relates to a thin film charge-storage device, which may be a thin-film battery, an electrochemical capacitor or a hybrid device, for example, wherein the device comprises two electrodes between a separator, wherein at least one of the electrodes is a polymer-based electrode according to the first embodiment.

Accordingly, depending on the desired application the thin film charge-storage device may include an electrode that is different from the polymer-based electrode described above and may be a polymer-based electrode or a non-polymer based electrode based upon lithium, lithium alloy, lithium insertion compounds and other metals, for example.

In a preferred embodiment, the thin film charge-storage device comprises: a first layer containing a first continuous, solid and porous electroactive polymer material, the electroactive polymer being a p-type conjugated organic polymer; and a second layer containing: a continuous, solid and porous electroactive polymer material, the electroactive polymer being an n-type conjugated organic polymer; wherein liquid electrolyte is present in the pores of both the first and the second continuous, solid and porous electroactive polymer material and the separator is provided between the first and the second layer.

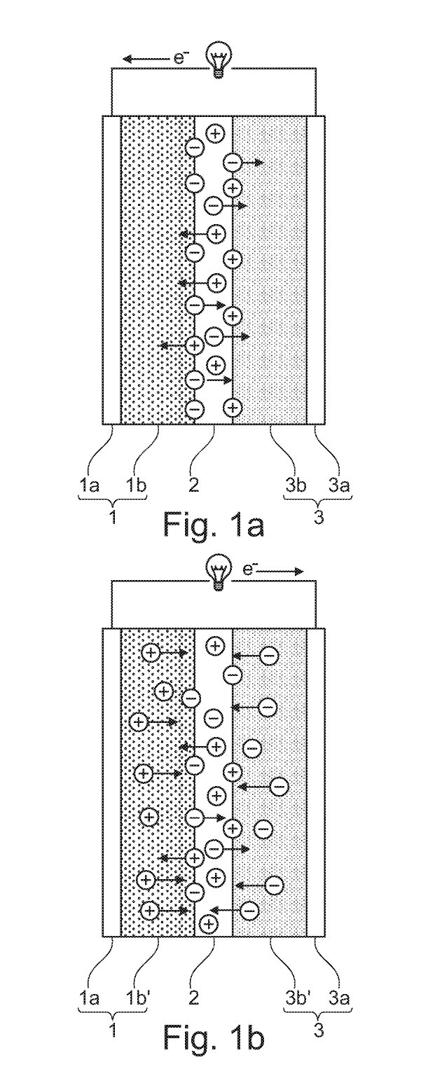

One specific example of such a thin film charge-storage device and its functioning is illustrated in FIGS. 1A and 1B. Herein, the electron flow and ion movement during charge (FIG. 1A) and discharge (FIG. 1B) is shown. During charging, the n-type polymer in the electroactive polymer layer (1b) at the cathode (1) becomes negatively charged (layer (1b′)), and cations from the electrolyte move in from the separator (2) to compensate the charge. Simultaneously, the p-type polymer in the electroactive polymer layer (3b) at the anode (3) becomes positively charged (layer (3b′)), and anions from the electrolyte move in to compensate the charge. During discharge, both polymers return to their neutral states, and ions return to the solution. In the illustration of FIGS. 1A and 1B, cathodic and anodic current collector layers (1a) and (3a) are employed, which, however, may be omitted if a conductive material is embedded into the polymer layers 1b/1b′ or 3b/3b′, as has been described above.

The separator is not particularly limited and may be made of known materials that are chemically and electrochemically unreactive with respect to the charges and to the electrode polymer materials in their neutral and charged states. Typically, the separator contacts the polymer-based electrode such that the transport of ions to and from the polymer-based electrode(s) is facilitated. As suitable materials, porous polymeric materials (e.g. polyethylene, polypropylene, polyester, teflon or cellulose-based polymers), ion-conductive polymer membranes (e.g. Nafion™), (electronically non-conductive) gel electrolytes (e.g. polymers, copolymers and oligomers having monomer units selected from the group consisting of substituted or unsubstituted vinylidene fluoride, urethane, ethylene oxide, propylene oxide, acrylonitrile, methylmethacrylate, alkylacrylate, acrylamide, vinyl acetate, vinylpyrrolidinone, tetraethylene glycol diacrylate, phosphazene and dimethylsiloxane) and cellulose-based gel electrolytes may be mentioned. Polymers, when used as a separator, should be resistant towards dissolution by the electrolyte, which may be appropriately achieved by methods known to the skilled artisan (e.g. by suitable selection of materials or by cross-linking).

It will be appreciated that the preferred features specified above may be combined in any combination, except for combinations where at least some of the features are mutually exclusive.

### Method of Preparation of Polymer-Based Electrodes and Thin Film Charge-Storage Devices

While it is to be noted that the polymer-based electrode in accordance with the first embodiment may be manufactured by conventional processes known in the art, a few specifically preferred methods will be explained below.

In particular, in a third embodiment the present invention relates to a method of forming a polymer-based electrode for a thin film charge-storage device, the method comprising: a step of processing a pre-formed electroactive polymer so as to provide a continuous and solid electroactive polymer material having a porous structure.

The term “pre-formed electroactive polymer” denotes an electroactive polymer, which is already present in its polymerized form (which may be already cross-linked or not). Said approach differs from a substantial majority of known methods for the preparation of polymer-based electrodes, wherein the polymer is deposited in situ (e.g. by electropolymerization) over which there is little control possible over the morphology and hence the performance of the polymer. Accordingly, in the methods of the present invention, the morphology of the electroactive polymer is altered after polymerization so that both the structure and stability of the polymer, the morphology of the polymer layer and the performance of the device can be optimised at the same time.

In another preferred embodiment of the present method of forming a polymer-based electrode in terms of simplicity and costs, the step of processing the pre-formed electroactive polymer comprises precipitating the pre-formed electroactive polymer from a solution thereof by addition of or to a liquid in which the polymer is non-soluble, and optionally cross-linking the deposited pre-formed electroactive polymer. Accordingly, the pre-formed electroactive polymer can be precipitated from a solution by adding and stirring an excess of a liquid in which it is insoluble (i.e. the non-solvent), or with the order of addition reversed, which is typically followed by a step of removing the solvent and liquid (e.g. by evaporation). It is preferable that the solvent in which the pre-formed polymer is dissolved has a lower boiling point than the non-solvent, so that during heating the polymer is concentrated in the non-solvent, which enables smooth precipitation and also prevents the electroactive polymer from being dissolved again upon evaporation of the non-solvent. Preferably, a solvent having a boiling point lower than 170° C., more preferably lower than 150° C. is used, including, but not limited to dichloromethane, toluene, xylene, chlorobenzene, tetrahydrofuran and other halogenated or aromatic solvents. The terms “non-soluble” and “insoluble”, as used herein, refer to the inability to be dissolved in a liquid in substantial amounts at room temperature, typically to a solubility of less than 0.1 mg/ml of the liquid. The nature and morphology of the precipitated polymer may be fine-tuned in dependence of the polymer structure and the solvent/liquid, and also the concentration in the solvent/liquid. However, typically the precipitated polymer will consist of a fine powder, resulting in an aggregate of electroactive polymer particles having an average particle diameter of between 1 nm and 10 μm, further preferably between 30 nm and 1 μm. In a further preferred embodiment, surfactants may be added to the polymer solution or be incorporated into the polymer, which allows smaller droplets of polymer solution to form, which then dry into the desired small particle sizes.

An alternative method of processing the pre-formed electroactive polymer is the production of an aggregate of electroactive polymer fibers, i.e. nano and/or microfibers having an average diameter of between 1 nm and 10 μm, preferably between 10 nm and 5 μm, by standard methods known in the art. The preparation of microfibers is well known for many materials, which can often have a diameter of less than 10 μm. Further enhancements of the surface area can be achieved by making split microfibers that can be done by the co-deposition of a second, soluble component within the fiber, whereupon subsequent dissolution of the second component reveals substantial gaps within the remaining fibre that can provide an effective diameter of 1 μm or less. An even further embodiment is to prepare nanofibers with diameters down to 1 nm to 1 μm, which can be achieved by using techniques such as electrospinning. These polymer aggregate layers can be used directly in the polymer-based electrode or charge-storage device or can be re-suspended in a liquid in which it is not soluble and deposited by any standard solution-processing technique.

Aggregates of electroactive polymer particles or electroactive polymer fibers having the characteristics described in the first embodiment may generally also be deposited from suspensions, wherein the suspension is formed by addition of pre-formed electroactive polymer present in the form of pre-formed electroactive polymer particles and/or pre-formed electroactive polymer fibers to a liquid in which these are non-soluble. While the deposited pre-formed electroactive polymer may already have the above-described desired structural properties, the pre-formed electroactive polymer may optionally also be subjected to a cross-linking step after deposition.

In another preferred embodiment, the step of processing the pre-formed electroactive polymer comprises: melting, softening or partially dissolving the pre-formed electroactive polymer; and subjecting the melted, softened or partially dissolved electroactive polymer to a foaming step. The resulting electroactive polymer material is preferably an open-cell foam, preferably a nano-, ultramicrocellular- or microcellular open-cell foam having a foam cell size between 0.1 nm and 10 μm. It is important that an open-cell foam is generated, as this interconnected set of pores can then be used to hold the ionic liquid and to expand the effective surface area of the polymer. The cellular structure of synthetic foams is created by blowing agents. Thus, the foaming step typically comprises the use of a blowing agent selected from chemical blowing agent or a physical blowing agent (inert gas, such as nitrogen, argon, carbon dioxide) to induce the foaming process. A preferred embodiment is to optimize the conditions so that the pores are very small, numerous, and very evenly distributed throughout the polymer layer.

In general, the method of the present invention may further comprise a step of incorporating liquid electrolyte into the porous structure of the continuous, solid and porous electroactive polymer material, which may be accomplished by methods known in the art. Herein, the liquid electrolyte may be defined as explained in the description of the first embodiment.

Normally, the polymer charge storage device requires an activation time of multiple charge cycles in order to reach maximum charge capacity, which may require a significant amount of time. This is believed to be due to a gradual increase in the incorporation of ions from the electrolyte into the polymer matrix, enabling subsequent faster movement of ions and an increasingly greater ability of the ions to penetrate further into the film, enabling in turn a greater capacity for injected electrical charges. In a preferred embodiment, which may be accomplished in combination with the above-described embodiments of the method of the present invention, the liquid electrolyte is added to the pre-formed electroactive polymer before or during processing of the pre-formed electroactive polymer. For example, when depositing the pre-formed electroactive polymer by precipitating the pre-formed electroactive polymer from a solution thereof, the liquid electrolyte may be added either to the solution prior to precipitation or, if used, to the liquid in which the polymer is non-soluble. When preparing the solution of the pre-formed electroactive polymer, it is preferable to use a solvent having a boiling point lower than 170° C., more preferably lower than 150° C. and which is physically and chemically compatible with both the ionic liquid and the polymer. Examples thereof include, but are not limited to dichloromethane, toluene, xylene, chlorobenzene, tetrahydrofuran and other halogenated or aromatic solvents. In another example, if the pre-formed electroactive polymer is deposited from a suspension, the liquid electrolyte is added before or during the deposition. Adding the liquid electrolyte to the pre-formed electroactive polymer before or during processing of the pre-formed electroactive polymer has the advantage that electrolyte ions may be incorporated into the porous structure of the polymer material during fabrication in a simple process which is easily scalable to larger devices. This technique further reduces the need for further ions to be brought into the polymer matrix during the activation process and thereby allows a reduction of the charge cycles required to reach maximum charge capacity, so that the activation period may be remarkably shortened.

In another embodiment, the step of processing the pre-formed electroactive polymer comprises forming the solid polymer network of a polymer gel by cross-linking of the electroactive polymer. Said method optionally further encompasses a step of incorporating liquid electrolyte into the porous structure by dispersing the electrolyte ions in the polymer gel. It is important in this case that the miscibility of the polymer in the ionic liquid is high so that gross phase separation does not occur. It is, however, also important that the polymer does not completely dissolve in the electrolyte so that it cannot leave the film and pass through the separator. This will also ensure that there is a fairly continuous pathway to ensure that electrical conductivity can be maintained between all of the polymer molecules. Cross-linking may be performed in a variety of ways including thermal crosslinking reactions (e.g. between a benzocyclobutene unit and an alkene). The desired miscibility can be achieved in a number of ways, although chemical modification—potentially including ionic groups—may be preferable. As explained above with respect to the first embodiment, the ratio of electroactive polymer to electrolyte may be adjusted to be approximately equal (e.g. 45:55 to 55:45) to provide for a relatively high charge-storage content, while gels with excess proportions of electrolyte ions (e.g. a ratio of 10:90 to 45:55) to will be able to release charge more quickly and thus lead to charge storage device attributes closer to a supercapacitor. Rather than needing to wait for ions to move fully in or out of the film, the high concentration of ions allows a Helmholtz double-layer to be formed around the charged polymer chain, which allows an extremely rapid release of charge.

In another preferred embodiment, which may be appropriately combined with any of the preferred embodiments described above, the step of processing the pre-formed electroactive polymer comprises physically embossing a layer of pre-formed electroactive polymer so as to provide a porous structure and thereby provide the continuous, solid and porous electroactive polymer material, which may be accomplished by embossing methods known in the art, such as hot embossing (see e.g. L. Peng et al., Journal of Micromechanics and Microengineering 2013, 24(1); M. Worgull, “Hot Embossing: Theory and Technology of Microreplication”, William Andrew, 2009, Elsevier). This can achieve physical pathways into the polymer layer so that the ions can penetrate it more easily and thereby further enhance the ion transport.

### EXAMPLES

### Example 1

A half-cell device has been manufactured by using a large surface-area carbon electrode as n-type material and a single a continuous, solid and porous electroactive polymer material formed by using a pre-formed p-type polymer (Compound 1).

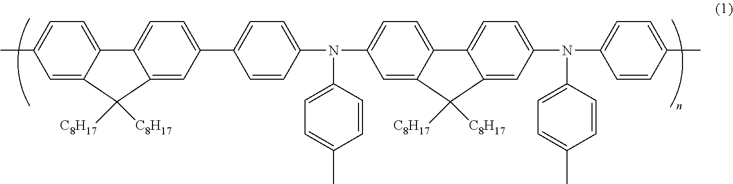

For this purpose, the polymer has been initially dissolved in toluene (at 10 mg/ml) and thereafter precipitated by slow dropwise addition into methanol (10 volume equivalents) with vigorous stirring, which results in a pale milky suspension that was filtered to form a solid but porous polymer layer.

### Comparative Example 1

A half-cell device has been manufactured in accordance with Example 1, with the exception that the p-type polymer (Compound 1) has been deposited by a spin-coating method to form a non-porous electroactive polymer layer.

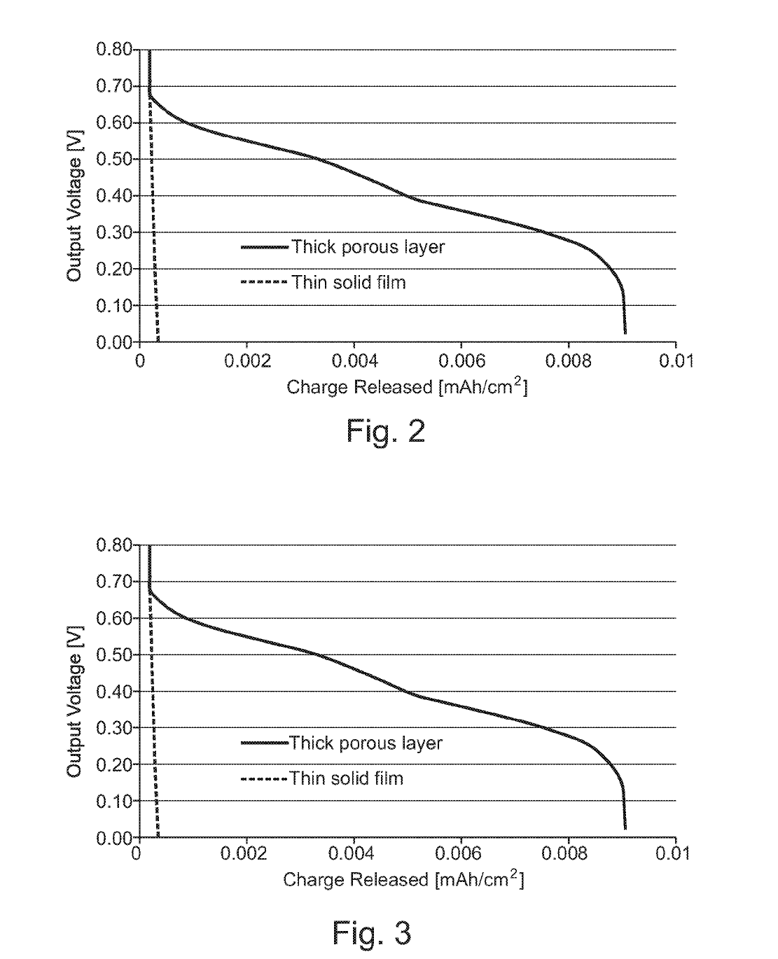

The charge-voltage output from the two half-cell devices according to Example 1 and Comparative Example 1 has been compared. As may be taken from FIG. 2, which is a graph displaying the released charge in dependence of the output voltage, the energy capacity of the half-cell employing the polymer-based electrode according to the present invention is substantially higher than that comprising the thin spin-coated film electrode.

### Example 2

A full-cell device has been manufactured by using a continuous, solid and porous electroactive polymer material formed by using a pre-formed p-type polymer (according to Compound 1) as one electrode and a pre-formed n-type polymer (Compound 2) according to the following structural formula for the preparation of the counter electrode.

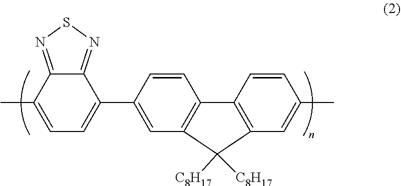

For this purpose, each of the polymers have been deposited in accordance with Example 1 to provide continuous, solid and porous electroactive polymer layers with identical morphologies.

### Comparative Example 2

A full-cell device has been manufactured in accordance with Example 2, with the exception that the electroactive polymer layers have been deposited by a spin-coating method to form non-porous n- and p-type electroactive polymer layers with identical morphologies.

The comparison of charge-voltage output from the two full-cell devices according to Example 2 and Comparative Example 2 in FIG. 3 demonstrates that a remarkable increase in stored charge is achieved by employing polymer-based electrodes according to the present invention.

### Example 3

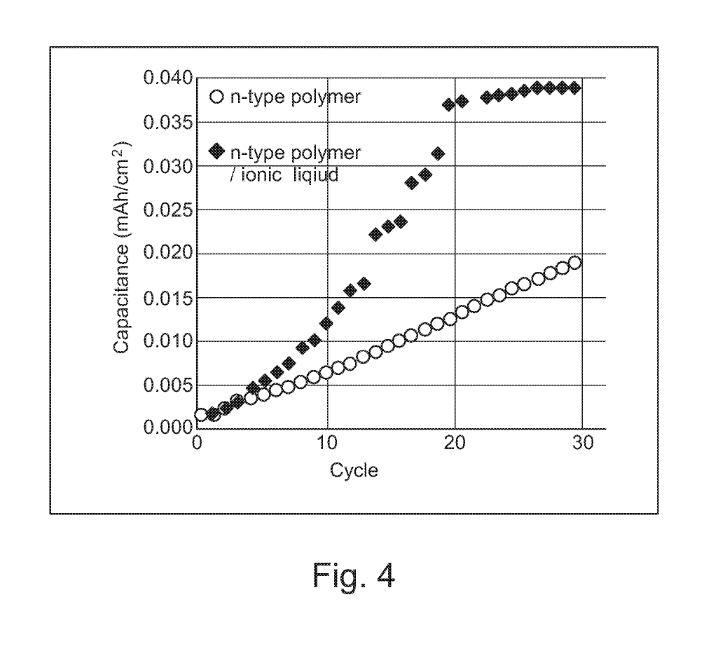

In an additional experiment, the charge capacity characteristics of a device comprising a polymer-based electrode, wherein liquid electrolyte has been added to the pre-formed electroactive polymer before or during the step of processing of the pre-formed electroactive polymer has been studied in comparison with a device, wherein liquid electrolyte has been added after formation of the layer of the continuous, solid and porous electroactive polymer material. For this purpose, a first device has been manufactured, wherein a porous electroactive polymer film with an active area of 5 cm² has been prepared by adding 0.5 ml of a dichloromethane/ionic liquid (2% w/w) solution to 5 mg of polymer, magnetically stirring the solution for 15 minutes, depositing the solution onto the substrate and allowing the solvent dichloromethane to evaporate so that the resulting film was a mix of ionic liquid and polymer. A second device has been prepared in the same manner and with the same materials, except that the ionic liquid has been added after drying of the polymer film, i.e. after formation of the porous structure. Thereafter, the dependence of capacitance on the number of charge cycles has been measured for each device. The results of the measurements shown in FIG. 4 demonstrate that—by addition of the ionic liquid before or during processing—less charge cycles are required to reach the maximum charge capacity, reducing the activation period for the manufactured device to approximately 20 hours, whereas the activation period in case of the device prepared by adding the ionic liquid after formation of the porous structure was approximately one week.

Once given the above disclosure, many other features, modifications, and improvements will become apparent to the skilled artisan.

### REFERENCE NUMERALS

1: cathode
1a: cathode current collector/substrate
1b/1b′: n-type conjugated polymer layer
2: separator
3: anode
3a anode current collector/substrate
3b/3b′: p-type conjugated polymer layer

1. A polymer-based electrode comprising at least one layer containing:
a continuous, solid and porous electroactive polymer material, and
liquid electrolyte present in the pores of the electroactive polymer material,
wherein the polymer material comprises an aggregate of fibres, a foam, or a gel.

2. The polymer-based electrode according to claim 1, wherein the electroactive polymer material is present in the form of an aggregate of electroactive polymer fibers having a diameter of between 1 nm and 10 μm, preferably between 10 nm and 5 μm.

3. The polymer-based electrode according to claim 1, wherein the electroactive polymer material is present in the form of an open-cell foam.

4. The polymer-based electrode according to claim 1, wherein the at least one layer is present in the form of a gel;
wherein the gel comprises the cross-linked electroactive polymer material as a solid polymer network into which a liquid phase comprising the liquid electrolyte is dispersed.

5. The polymer-based electrode according to claim 1, wherein the at least one layer exhibits a non-planar surface.

6. The polymer-based electrode according to claim 1, wherein the polymer constituting the electroactive polymer material is a conjugated organic polymer, preferably an n-type or a p-type conjugated organic polymer.

7. The polymer-based electrode according to claim 6, wherein the n-type conjugated organic polymer is an in-chain conjugated (co-)polymer of monomers selected from at least one of the group of fluorenyl derivatives, heteroaromatic hydrocarbons, conjugated aromatic hydrocarbons, and carbonyl-based monomers; and/or wherein the p-type conjugated organic polymer is an in-chain conjugated (co-)polymer of monomers selected from at least one, more preferably at least two of the group of fluorenyl derivatives, phenylene derivatives, aniline derivatives, dialkylarylamines, diarylalkylamines, diarylamines, triarylamines and heteroaromatic hydrocarbons; the heteroaromatic hydrocarbons being preferably selected from thiophene, dithiene, benzothiophene and their derivatives.

8. A thin film charge-storage device comprising two electrodes between a separator, wherein at least one of the electrodes is a polymer-based electrode according to claim 1.

9. The thin film charge-storage device according to claim 8, comprising:
a first layer containing a first continuous, solid and porous electroactive polymer material, the electroactive polymer being a p-type conjugated organic polymer; and
a second layer containing: a continuous, solid and porous electroactive polymer material, the electroactive polymer being an n-type conjugated organic polymer;
wherein liquid electrolyte is present in the pores of both the first and the second continuous, solid and porous electroactive polymer material and the separator is provided between the first and the second layer.

10. A method of forming a polymer-based electrode for a thin film charge-storage device, the method comprising:
a step of processing a pre-formed electroactive polymer so as to provide a continuous and solid electroactive polymer material having a porous structure.

11. The method of forming a polymer-based electrode for a thin film charge-storage device according to claim 10, wherein the step of processing the pre-formed electroactive polymer comprises:
a step of depositing the pre-formed electroactive polymer by precipitating the pre-formed electroactive polymer from a solution thereof, preferably by addition of or to a liquid in which the polymer is non-soluble; and
optionally a step of cross-linking the deposited pre-formed electroactive polymer.

12. The method of forming a polymer-based electrode for a thin film charge-storage device according to claim 10, wherein the step of processing the pre-formed electroactive polymer comprises:
a step of depositing the pre-formed electroactive polymer from a suspension, wherein the suspension is formed by addition of pre-formed electroactive polymer present in the form of pre-formed electroactive polymer particles and/or pre-formed electroactive polymer fibers to a liquid in which these are non-soluble; and
optionally a step of cross-linking the deposited pre-formed electroactive polymer.

13. The method of forming a polymer-based electrode for a thin film charge-storage device according to claim 10, wherein the step of processing the pre-formed electroactive polymer comprises:
melting, softening or partially dissolving the pre-formed electroactive polymer, and
subjecting the melted, softened or partially dissolved electroactive polymer to a foaming step.

14. The method of forming a polymer-based electrode for a thin film charge-storage device according to claim 10, wherein liquid electrolyte is added to the pre-formed electroactive polymer before or during the step of processing of the pre-formed electroactive polymer.

15. The method of forming a polymer-based electrode for a thin film charge-storage device according to claim 10, wherein the step of processing the pre-formed electroactive polymer comprises physically embossing a layer of pre-formed electroactive polymer so as to provide a porous structure and thereby provide the continuous, solid and porous electroactive polymer material.

16. The method of forming a polymer-based electrode for a thin film charge-storage device according to claim 10,
wherein the step of processing the pre-formed electroactive polymer comprises forming the solid polymer network of a polymer gel by cross-linking of the electroactive polymer, and
wherein the method optionally further encompasses a step of incorporating liquid electrolyte into the porous structure by dispersing the electrolyte ions in the polymer gel.

17. The method of forming a polymer-based electrode for a thin film charge-storage device according to claim 10, further comprising a step of incorporating liquid electrolyte into the porous structure of the continuous, solid and porous electroactive polymer material.
